(19) United States
(12) Patent Application Publication
(10) Pub. No.: US 2016/0296305 A1
(43) Pub. Date: Oct. 13, 2016

(54) ARTIFICIAL TOOTH AND METHOD FOR PRODUCING A DENTURE BASE

(71) Applicant: VITA ZAHNFABRIK H. RAUTER GMBH & CO. KG, Bad Säckingen (DE)

(72) Inventors: Jürgen Förtsch, Bad Säckingen (DE); Franz Egle, Bad Säckingen (DE); Eva Kerschensteiner, Bad Säckingen (DE); Urban Christen, Bad Säckingen (DE)

(21) Appl. No.: 15/038,625

(22) PCT Filed: Nov. 13, 2014
(86) PCT No.: PCT/EP2014/074498

§ 371 Date: May 23, 2016

(30) Foreign Application Priority Data
Nov. 26, 2013 (EP) 13194419.1

(51) Int. Cl. A61C 13/08; A61C 13/10; A61C 13/00; A61C 13/01

(52) U.S. Cl. CPC A61C 13/08; A61C 13/01; A61C 13/10; A61C 13/0004

(57) ABSTRACT

Artificial teeth are inserted into a denture base for producing a denture. The artificial teeth have an outer part, which is visible in the inserted state. An inner part is arranged within the denture base in the inserted state. A tooth edge with a change of angle is embodied between the outer part and the inner part. For producing a denture base, cavities are generated in the denture base. In order to be able to produce the cavities with the aid of automated production methods such as CAD/CAM methods, there is a virtual subtraction of the artificial teeth from a virtual denture base. As a result of this, a cavity edge which corresponds to the tooth edge is generated. The cavity edge is used during the production of the cavity by a CAD/CAM method for setting the tool movement.

The invention relates to an artificial tooth for insertion into a denture base, as well as to a method for producing a denture base.

Today, the standard of providing patients with partial and full denture is generally high. A dentist prepares the situation to be treated at the patient, while the (partial) denture is usually manufactured by a dental technician in an external laboratory or a practice laboratory according to the specifications given by the dentist. The quality of the denture largely depends on the craftsmanship of the dental technician that has to observe the dentist's specifications when producing the denture, as well as on the quality of these specifications.

Further, the preparation of the patient to be provided with a denture often comes with discomfort to the patient. In this context one may mention for example various sessions with the treating dentist during which impressions of the situation to be attended to have to be made which the dental technician uses as negative models. The subsequent further impressions are time-consuming and often are the reason for a defective realization of the prosthetic restoration. Typically, two or three sessions for obtaining impressions are required before the dental technician can begin with the actual production of a denture.

WO2011/066895 A1 relates to a method for an automated production of dentures, comprising the steps of providing a digital data set of the individual denture to be produced, digitally separating the model into dental arch and gingiva, manufacturing the dental arch from ceramics and plastic material by means of milling techniques or manufacturing the denture base by generative of ablative processes from predominantly (meth-)acrylate-based plastic materials, connecting the dental arch and the gingiva by bonding or joining or a combination of bonding and joining.

EP 2 111 180 A1 relates to a method for manufacturing a base part of a set of artificial teeth or a set of artificial teeth having a base part, comprising the step of forming the base part using a rapid prototyping method such as e.g. 3D lithography and in particular laser 3D lithography. Further, a method for generating a data set is disclosed, the data set indicating the shape of a base part of a set of artificial teeth, where a gingiva area or a model thereof is scanned and/or a model of a base part is scanned and/or the shape of the base part is simulated on a computer.

EP 1 864 627 A2 discloses a method for producing dentures using a digitized virtual model representing the maxillary situation, the method comprising the steps of digitally acquiring the maxillary situation and relationship, digital modeling (optionally automatically), producing a divided negative mold (rapid manufacturing) from the data of the digital modeling of the tooth, inserting the fabricated teeth/fabricated dental units into the open negative molds, closing the negative molds and filling the remaining cavities with plastics for the denture.

EP 1 444 965 A2 relates to a method for the production of dentures, with the steps of recording and digitizing (scanning) the 3-dimensional, anatomical relationships in the oral cavity, if applicable recording and digitizing (scanning) the 3-dimensional data of bite molds incl. bite blocks, if applicable recording the jaw data which are normally taken on the patient for adjusting the articulator, processing the obtained data set such that the relevant anatomical structures are secure for a virtual tooth placement and a virtual model is obtained as data set, followed by the selection of the 3-D data sets of fabricated, previously scanned-in teeth from a further data set, virtual placement of the teeth into the virtual model as the second data set, followed either by a transfer of the virtual placement of the teeth onto the model either by a positioning template (e.g. milled or rapid-prototyped) or a direct placement of the fabricated teeth into the model, fixing the teeth on the model, mounting the denture base, or according to another alternative, followed by a direct manufacture of the prosthesis base—according to the data of the virtual tooth placement—with positioning aids for the final correct positioning and fixing of the fabricated teeth.

WO 2008/005432 A2 discloses a system for fabricating at least a portion of a denture. The system includes a three-dimensional scanning device for scanning a surface of a denture template, and a computer-readable medium including a computer program for receiving data from the scanning device, creating a 3-dimensional model of the surface, and optionally modifying the 3-dimensional model and/or adding features to the 3-dimensional model. The system also includes a processing for creating at least a portion of the denture from a selected material, based on the 3-dimensional model. The processing may be ablative or generative.

It is an object of the invention to provide artificial teeth suited to improve the method of producing a denture base, wherein it is intended to enable in particular an automated method for manufacturing a denture base.

The object is achieved with an artificial tooth as defined in claim 1 and a method for producing a denture bas as defined in claim 7.

An artificial tooth of the present invention for insertion into a denture base has an outer part and an inner part. The outer part is the part of the tooth that remains visible after the tooth has been inserted into the denture base. The inner part is the part of the tooth that is arranged in the denture base in the inserted state of the tooth. According to the invention a tooth edge is formed between the outer portion and the inner portion. As will be described hereunder with respect to the method of the present invention, forming such a tooth edge has the advantage that this edge can be detected or used by an automatic production process, such as a CAD/CAM system, to produce a cavity in the denture base, in particular automatically e.g. by milling. The artificial tooth is then inserted, in particular glued into this cavity in the denture.

According to the invention the artificial tooth shows a change of angle at the edge. Therefore, the tooth edge forms a clearly discernible, defined edge or line. There is no smooth transition between the outer part and the inner part of the tooth at the tooth edge. Rather, there is an abrupt change of angle. Therefore, a function of the course of the angle would be discontinuous in the region of the tooth edge. The change of angle preferably is in a range between 3°-80°. The angle results from the difference between the two adjoining angles.

In particular for reasons related to manufacturing technology, the artificial tooth has no mathematically sharp edge. Rather, the edge has a very slight, in particular production-related rounding.

It is further preferred to design the inner part of the artificial tooth such that no undercuts exist with respect to the direction of fitting or insertion in which the tooth is inserted into the denture base. This significantly facilitates insertion. In particular, it is much simpler to form the cavity in the denture base which accordingly also has no undercut in the direction of insertion.

The artificial tooth of the present invention is preferably developed such that the tooth edge is formed to extend all around the circumference. Thus, the tooth edge is a closed edge. This is advantageous in particular with automatic production processes, such as CAD/CAM processes.

It is further preferred that only the outer part of the artificial tooth is worked for the purpose of individualizing the tooth shape. This has the advantage that a clearly defined inner part exists that is important in particular for automation and that therefore the cavities can be formed automatically in the denture base. Thus, the shape and the depth of the cavities are clearly predetermined.

Further, it is preferred that the inner part of the artificial tooth is asymmetric in shape. In particular, the inner part is not rotationally symmetric in shape. Thereby, an erroneous insertion into the denture base is avoided.

For a complete production of a denture a plurality of teeth according to the present invention exists in a library from which a certain arrangement of teeth may be selected.

Further, a denture base is provided for producing a denture. The denture base has a plurality of cavities, each for receiving an artificial tooth as described above and developed in an advantageous manner. In this regard, the individual cavities are formed such with respect to the direction of insertion of the respective artificial tooth into the denture base that the cavities are free of undercuts. This enables a simple positioning of the artificial teeth in the corresponding denture base.

Preferably, the individual cavities of the denture base are formed complementarily to the respective inner part of the respective artificial tooth to be inserted. Thereby, a gap of constant width is formed between the respective cavity and the inner part of the associated tooth. This guarantees a secure fastening of the artificial tooth in the denture base.

In particular when using asymmetric, especially not rotationally symmetrically shaped artificial teeth, the cavities are also given a correspondingly asymmetric shape and especially a not rotationally symmetrical shape in a preferred embodiment. This has the essential advantage that an unambiguous allocation of a respective artificial tooth to a corresponding cavity, as well as an unambiguous positional definition of the corresponding tooth in the cavity is clearly and unambiguously defined.

Therefore, it is particularly preferred that all cavities differ in shape so that an unambiguous correlation exists between the artificial tooth and the cavity. Thus, an erroneous insertion is excluded.

It is further preferred that the cavities are formed, in particular have a depth such that an inserted artificial tooth has a defined tooth height.

Further, it is particularly preferred especially for esthetic reasons that the tooth edge of the artificial tooth, where the change of angle occurs, coincides at least in part, in particular entirely with the cavity edge in the inserted state or that the two edges overlap each other in particular completely.

In the method of the present invention for producing a denture base, at least one artificial tooth of the present invention is virtually embedded in a virtual denture base or virtual gingiva. In the next step a cavity edge is defined at a tooth equator of the tooth edge based on the change of angle. This is still done virtually so that a virtual cavity edge is made in the virtual denture base for the at least one tooth of the present invention. Preferably, the cavity edge coincides with the tooth edge in the finished state of the denture with the artificial tooth inserted. After the at least one cavity edge has been defined, the actual denture base is mad by forming a cavity in a base body of a denture. This is done in particular by milling the cavity. The cavity is preferably formed by a CAD/CAM process. According to the invention, for performing a CAM process, the cavity edge serves to define a tool movement. In this regard, the cavity edge serves as a limit curve for establishing a milling strategy. In the CAM, the milling paths are generated from the limit curve and the known cavity geometry. For the production process, the necessary parameters of a milling process, which are known from prior art, are defined (rotational speed, forward feed, feed in the lateral and depth directions, . . . ).

It is particularly preferred that defining the virtual cavity edge is done by virtually subtracting the tooth from the virtual denture base. Thus, it is possible to transfer the tooth edge to the virtual denture base and to thereby define the cavity edge in a simple manner.

In a particularly preferred embodiment the cavity to be made in the denture base by a CAD/CAM process is formed complementary to the lower side or the inner part of the tooth. It is possible to thereby define a bonding gap having a constant width or thickness over the entire bonding surface. This is advantageous in that an extremely precise and clearly defined insertion of the tooth into the cavity is ensured. It is another advantage that due to the clearly defined bonding gap, the volume of the bonding gap is also clearly defined and therefore a predetermined quantity of adhesive can be introduced into the cavity, whereby it can be avoided that adhesive is pressed out in the region of cavity edge or the tooth edge. This has the advantage that the post-processing steps are simplified or may even be mitted altogether.

In particular to allow for a good automation it is particularly preferred that also the cavities in the denture base are formed such that no undercuts exist in the direction of insertion or introduction of the tooth.

Since the artificial teeth are preferably made of plastic material and the manufacture is performed using generally two-part molds, a mold parting edge is formed. Here, the mold parting edge is defined by the border of the in particular two molds. The mold parting edge has to be arranged such that a simple demolding of the tooth from the mold parts is possible. The mold parts are designed such that no undercuts exist so as to enable a simple removal of the tooth from the mold part. It is particularly preferred that the mold parting edge coincides at least in part with the tooth edge. This has the advantage that the mold parting edge is at least partly invisible when the tooth is inserted in the denture base and that a postprocessing is therefore not necessary.

It is particularly preferred that a plurality, in particular all of the teeth of a dental arch are embedded into the virtual denture base using the method of the present invention described above with reference to one tooth. Accordingly, it is preferred that all associated cavity edges are defined in particular by virtual subtraction and that all associated cavities are thereafter formed as described above with reference to one tooth, preferably using a CAD/CAM process.

Prior to the at least one tooth of the present invention being embedded as provided by the invention into a virtual denture base, the following method steps may preferably be performed:
acquiring the oral situation of a patient by impressions or by digital recording,
if applicable, digitizing the oral situation of the patient,
selecting the teeth forming the denture from an ideal calculated set-up according to a corresponding set-up concept for teeth or groups of teeth, wherein a virtual set-up of the teeth is obtained that is positioned virtually in a space that takes into account the patient situation captured,
virtual embedding of the teeth arranged in the virtual set-up into a virtual denture base.

The set-up concept is established by a treating practitioner, in particular with respect to a patient's specific needs.

Partial or full prosthesis means a denture that is removable, conditionally removable, or permanently attached.

The taking of an impression of the situation of the patient's mouth (patient's situation) can be effected, in particular, by using impression materials. According to the invention, the impression can be advantageously used as a putty impression, second impression (functional impression), and bite registration.

In the method according to the invention, the impression can be taken with conventional devices, so-called impression trays. An impression tray that enables a mucosa-congruent seat is particularly suitable. The border regions are to be reduced. The impression tray is to be capable of receiving impression material, and of receiving a vertical mechanism for bite adjustment, and susceptible to posterior geometries for bite fixation.

In one embodiment of the present invention, the digital recording of the patient's situation is performed by means of imaging, especially optical, methods, such as camera recording, computer tomography, ultrasound.

In another embodiment of the method according to the invention, the library contains representations of dental arches, dental shapes, dental sizes, dental shapes/sizes and combinations thereof, as can be seen, for example, from Vita charts Nos. 1694 and 1756. Total set-ups and/or modular set-ups for all Angle's bite classes are preferably considered in the library. If desired, the library may also contain designs of the gingiva in different age manifestations.

The method according to the invention advantageously enables the dental arch to be adapted to the individual span and curve of the patient's jaw by considering virtual hinges that are widened by a function in the form of a motion element (inward and outward motions), for example, between teeth 11 and 21 in the upper jaw and teeth 31 and 41 in the lower jaw. The design of the gingiva can be individualized virtually, for example, by inserting palatine folds or adapting the palatal vibrating line and the scrapings. For the palatine folds, deposited virtual models of the folds are preferably inserted into the virtual model of the prosthesis. It may be convenient to change the models individually in accordance with the denture shape, for example, by stretching and compressing and by mapping onto the palatal surface. The scraping is modified by virtual changes of the material thickness near the palatal vibrating line, and the palatal vibrating line itself can be indicated as a curve or bordering line and changed in the virtual model.

These method steps are described in detail in PCT/EP2013/062279.

The invention will be described hereunder with reference to a preferred embodiment and to the accompanying drawings.

In the Figures:

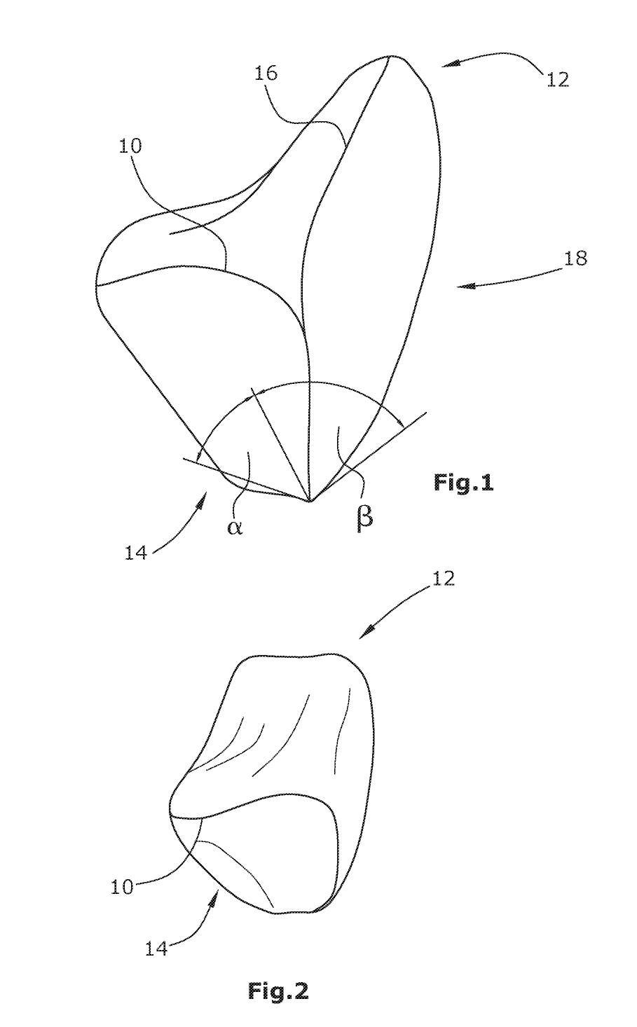

FIG. 1 is a schematic perspective side view of an artificial tooth of the present invention,

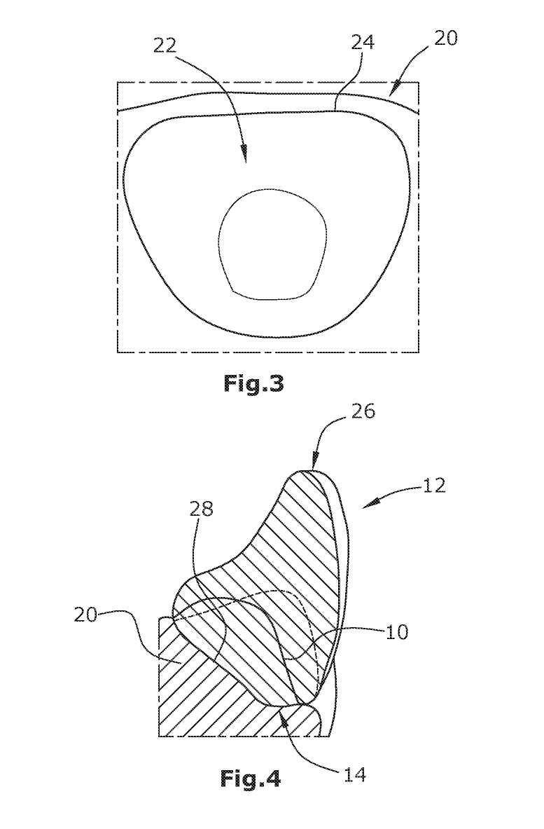

FIG. 2 is a schematic perspective re view of an artificial tooth of the present invention,

FIG. 3 is a schematic perspective top plan view of a cavity in a denture base,

FIG. 4 is a schematic sectional view of a tooth inserted into the cavity base, and

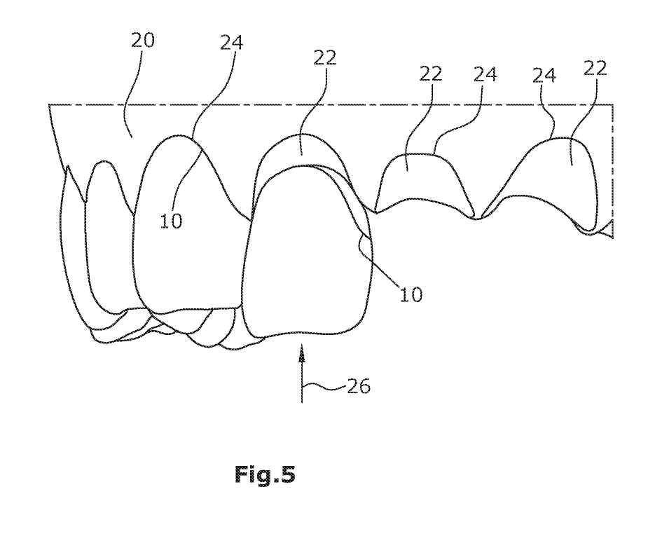

FIG. 5 is a perspective view of a denture base with some artificial teeth inserted.

For preparing a complete denture, i.e. a denture base in which the artificial teeth are placed, the following steps are executed for example:
acquiring a patient's oral situation by taking an impression or by digital recording;
if required, digitizing the patient's oral situation;
selecting the teeth forming the denture from an ideal calculated set-up corresponding to a set-up concept of teeth or groups of teeth, thereby obtaining a virtual set-up of the teeth, which is positioned virtually in a space that takes the acquired patient's situation into account;
virtually embedding the teeth arranged in the virtual set-up in a virtual gingiva or a virtual denture base;
producing the real prosthesis.

This method is described in particular in PCT/EP2013/062279.

According to the invention this method is developed in such a manner that artificial teeth are used that are formed as provided by the present invention. A corresponding library therefore includes a plurality of teeth designed according to the present invention. These differ in tooth size, shape etc. The artificial teeth of the present invention have in common in particular the design of a tooth edge with a change of angle.

The tooth edge 10 is visible in the example of a tooth illustrated in FIGS. 1 and 2, the tooth being is an incisor. The artificial tooth illustrated as an example has an outer part 12 and an inner part 14. The outer part 12 is separated from the inner part 14 by the tooth edge 10. With the artificial tooth inserted into the denture base, the outer part is arranged outside the denture base and is visible. In the inserted state, the inner part 14 is arranged inside the denture base and is thus not visible.

The tooth edge 10 is formed as a fully closed circumferential edge. The preferred change of angle according to the invention is provided at this edge. The transition between the outer part 12 and the inner part 14 is thus not continuous or smooth in the area of the tooth edge 10. Rather, the angle changes abruptly. The angle is obtained from the difference between the two adjoining angles α and β.

Since the artificial tooth preferably is a tooth made of plastic material, the same is produced using in particular two mold parts. Due to the provision of mold parts a mold edge 16 is formed. The same is preferably arranged such that it cannot or only hardly be seen when viewed in a viewing direction 18. The viewing direction 18 is the viewing direction of a third person looking at the denture placed in the mouth of the patient. It is particularly preferred that the mold parting edge 16 coincides at least in part with the tooth edge 10. In FIG. 1, this is the case in the lower region, with the opposite side of the tooth not shown being of a corresponding design.

For producing a denture base 20 (FIG. 3), first, the individual teeth are subtracted from a virtual denture base. This allows a virtual generation of a denture base 20 with a respective cavity 22 formed corresponding to each tooth. The virtual denture base 20 thus has a cavity 22 defined by a cavity edge 24. The cavity edge 24 is formed by virtual subtraction of the tooth from the denture base 20 and corresponds to the tooth edge 10.

The cavities 22 are formed in the denture base 20 preferably using CAD/CAM processes. These use the cavity edge 24 to define the milling paths or the movement paths of other tools. This allows a very exact and automatic forming of the cavities 22.

Since it is particularly preferred that the inner part 14 of the teeth has no undercuts in the direction of insertion 26 (FIG. 4) of the teeth into the cavities 22, a simple mounting or a simple insertion/bonding into the cavities 22 is possible. In this regard the cavities 22 are also free of undercuts in the corresponding direction of insertion 26. The direction of insertion 26 is substantially orthogonal to the denture base. With the denture arranged in the oral cavity, the direction of insertion would be substantially vertical.

In order to avoid undercuts both at the inner part 14 and in the cavity 22, the inner part 14 is formed to taper outward starting from the tooth edge. In particular, the inner part 14 is designed conically at least in part. The corresponding cavity 22 is formed complementarily to the inner part so that an exact definition of the tooth's position in the cavity 22 is provided. Using a complementary design of the inner part 14 and the cavity 22, it is further possible to provide a bonding gap 28 (FIG. 4) that has a constant width over its entire surface. Thus, also the volume of the bonding gap and therefore the required quantity of adhesive are known exactly.

FIG. 4, which is a sectional view of the tooth and the denture base 20, further shows the tooth edge 10. Here, with respect to the cut surface of the tooth, the part of the tooth edge 10 illustrated as a solid line extends in front of the drawing plane and the part illustrated as a broken line extends behind the drawing plane.

For a complete production of a denture, the denture base 20 is provided with a plurality of cavities 2 (FIG. 5). First, a clearly defined quantity of adhesive is introduced into the individual cavities and then the corresponding teeth are inserted into the cavities 22 in the direction of insertion 26. With the teeth inserted, the cavity edge 24 and the tooth edge 10 overlap.

What is claimed is:

1. Artificial tooth for insertion into a denture base, comprising
an outer part visible in the inserted state, and
an inner part arranged in the denture base when in the inserted state, wherein
a tooth edge with a change of angle is formed between the outer part and the inner part and the inner part is free of undercuts with respect to a direction of insertion in which the tooth is inserted into the denture base.

2. Artificial tooth of claim 1, wherein the tooth edge extends all around the circumference thereof.

3. Artificial tooth of claim 1, wherein the change of angle at the tooth edge is in a range from 3°-80°.

4. Artificial tooth of claim 1, wherein a mold parting edge coincides at least in part with the tooth edge.

5. Artificial tooth of claim 1, wherein the inner part is asymmetric.

6. Denture base with a plurality of cavities for receiving a respective artificial tooth comprising: an outer part visible in the inserted state, and an inner part arranged in the denture base when in the inserted state, wherein a tooth edge with a change of angle is formed between the outer part and the inner part and the inner part is free of undercuts with respect to a direction of insertion in which the tooth is inserted into the denture base, wherein the cavities are free of undercuts with respect to the direction of insertion in which the tooth is inserted into the denture base.

7. Denture base of claim 6, wherein the cavities are formed complementarily to the inner parts of the corresponding artificial tooth to be inserted, so that a gap of constant width is formed between the cavities and the inner part of the associated tooth.

8. Denture base of claim 6, wherein the cavities are asymmetric.

9. Denture base of claim 6, wherein all cavities differ in shape so that an unambiguous correlation exists between the artificial tooth and the cavity.

10. Denture base of claim 6, wherein the cavities are formed such that an inserted artificial tooth has a defined tooth height.

11. Denture having a denture base as defined in claim 6 into which said artificial tooth is inserted, wherein the cavity edges and the tooth edges overlap each other at least in part.

12. Method for producing a denture base, the method comprising the following steps:
virtual embedding of at least one artificial tooth of claim 1 in a virtual denture base,
defining a cavity edge based on the change of angle at the tooth equator and
producing the real denture base by forming at least one cavity in a base body of a denture.

13. Method for producing a denture base of claim 12, wherein the cavity edge is defined by virtual subtraction of the tooth from the virtual denture base.

14. Method for producing a denture base of claim 12, wherein forming the cavity is performed using a CAD/CAM process, the cavity edge serving to define the tool movement.

15. Method for producing a denture base of claim 12, wherein the cavity is produced to form a bonding gap of constant width in a manner complementary to the lower side of the artificial tooth.

16. Method for producing a denture base of claim 12, wherein the cavities are formed without undercuts in the direction of insertion of the artificial tooth.

17. Method for producing a denture base of claim 12, wherein a plurality, preferably all teeth of a dental arch are embedded virtually, all associated cavity edges are defined and all associated cavities are formed.

18. Method for producing a denture base of claim 12, wherein at least the following steps are performed prior to the virtual embedding of the at least one said artificial tooth:
acquiring the oral situation of a patient by impressions or by digital recording,
if applicable, digitizing the oral situation of the patient,
selecting the teeth forming the denture from an ideal calculated setup according to a corresponding set-up concept for teeth or groups of teeth, wherein a virtual set-up of the teeth is obtained that is positioned virtually in a space that takes into account the patient situation captured,
virtual embedding of the teeth arranged in the virtual set-up into a virtual denture base.

19. Artificial tooth of claim 5, wherein the inner part is not rotationally symmetric in shape.

20. Denture base of claim 8, wherein the cavities are not rotationally symmetric in shape.
